(19) United States
(12) Patent Application Publication
(10) Pub. No.: US 2023/0111337 A1
(43) Pub. Date: Apr. 13, 2023

(54) Systems, Methods, and Devices, for Perceptual Hashing Through Entropic Sampling

(71) Applicant: Zestbloom, Inc., Morrisville, VT (US)

(72) Inventor: Evan Maltz, West Hills, CA (US)

(73) Assignee: Zestbloom, Inc., Morrisville, VT (US)

(21) Appl. No.: 17/963,966

(22) Filed: Oct. 11, 2022

Related U.S. Application Data
(60) Provisional application No. 63/254,314, filed on Oct. 11, 2021.

(51) Int. Cl. G06F 16/53; G06F 16/50

(52) U.S. Cl. CPC G06F 16/53; G06F 16/50

(57) ABSTRACT

A method and a computing device for integrating digital content into a database by, in some embodiments, segmenting the digital content into at least one region, sampling the at least one region of the digital content, and selecting the at least one region of the digital content, based on the sampling. In some embodiments, the method may include, and computing device may perform, quantizing the digital content into at least one fragment, based at least on the selecting, compressing the at least one quantized fragment into at least one pHash, and selecting and storing the at least one pHash. In some examples, the storing may be on a blockchain. In some examples, the at least one region may be distinct from the at least one fragment.

### CROSS-REFERENCE TO RELATE APPLICATION(S)

This application claims benefit to U.S. Provisional Application No. 63/254,314, filed on Oct. 11, 2021, and entitled “Systems, Methods, And Devices For Perceptual Hashing Through Entropic Sampling,” the contents of which are incorporated by reference herein as though set forth in their entirety, and to which priority and benefit are claimed.

### FIELD OF USE

The present disclosure relates generally to the field of perceptual hashing. More specifically, the disclosure relates to systems, methods, and devices for scopic perceptual hashing through entropic sampling that enables content-agnostic coordinate sampling and allows for a content-based, federated search engine.

### BACKGROUND

Perceptual hashing refers generally to the use of algorithms to analyze data, such as various forms of multimedia, and produce a representative snippet of that data. More specifically, it refers to non-cryptographic algorithms that attempt to map a content space. The end-product of perceptual hashing is a hash—a unique, fixed-length string representing the analyzed data. For example, in relation to image content, perceptual image hashing generates content-based image hashes. Thus, hashes, as one skilled in the art understands, represent a unique identifier for the multimedia analyzed. Perceptual hashing provides various advantages over the cryptographic approaches currently used on blockchains, such as the ability to detect redundant images, perform reverse image-search, and flag/filter unauthorized images; all of which is accomplished by comparing query hashes to a decentralized database of hashes.

However, there are limitations to existing systems, methods, hardware, and devices that allow for perceptual hashing. Primarily, perceptual hashing, as it currently exists, is not affine-transformation invariant and fails on collages. And existing implementations that are 2D-transformation invariant are not memory efficient, nor are they content-agnostic. Furthermore, image hashes have not been integrated with blockchain for decentralized indexing of digital media. As a result, when addressing search-engine needs, individuals and companies are forced to use highly sophisticated image-analysis algorithms that can only crawl through the internet for data. Existing limitations also result in a failure to leverage blockchain technology to transparently maintain a decentralized, content-based index for databases of images and/or image hashes and for other multimedia beyond images, such as video and audio content.

Thus, what is needed are systems, methods, and devices for improving perceptual hashing and the integration of hashes with blockchain technology while being content-agnostic.

### SUMMARY OF THE DISCLOSURE

The following presents a simplified overview of the example embodiments to provide a basic understanding of some embodiments of the present disclosure. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented herein below. It is to be understood that both the following general description and the following detailed description are exemplary and explanatory only and are not restrictive.

A method for integrating digital content is disclosed. In some embodiments, the digital content may be integrated into a database. In some embodiments, the method may include segmenting the digital content into at least one region. In some embodiments, the method may also include sampling the at least one region of the digital content. In some embodiments, the method may also include selecting the at least one region of the digital content. In some embodiments, the selecting may be based at least in part on the sampling.

In some embodiments, the method may also include quantizing the digital content into at least one fragment. In some embodiments, the quantizing may be based at least in part on the selecting. In some embodiments, the method may also include compressing the at least one quantized fragment into at least one pHash. And in some embodiments, the method may also include selecting and storing the at least one pHash. In some cases, the storing may be on a blockchain. In some examples, the at least one region may be distinct from the at least one fragment.

A computing device is also disclosed, which may include a processor, a memory, and a non-transitory, computer-readable medium operably coupled to the processor. The computer-readable medium may have computer-readable instructions stored thereon that, when executed by the processor, cause the computing device to: segment the digital content into at least one region; sample the at least one region of the digital content; and select, based at least in part on the sampling, the at least one region of the digital content. When executed by the processor, the computer-readable instructions may also cause the computing device to: quantize, based at least in part on the selecting, the digital content into at least one fragment; compress the at least one quantized fragment into at least one pHash; and store the at least one pHash.

Advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure. As will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The accompanying drawings, which are incorporated in and constitute a part of this specification, illustrate embodiments of the disclosure and together with the general description of the disclosure given above and the detailed description of the drawings given below, serve to explain the principles of the disclosure. In certain instances, details that are not necessary for an understanding of the disclosure or that render other details difficult to perceive may have been omitted.

FIG. 1A generally illustrates an embodiment of entropic coordinate sampling as disclosed herein.

FIG. 1B generally illustrates an embodiment of entropic coordinate sampling as disclosed herein.

FIG. 2 generally illustrates an embodiment of entropic coordinate sampling as disclosed herein.

FIG. 3 is a functional block diagram generally illustrating an embodiment of a network system for entropic coordinate sampling as disclosed herein.

FIG. 4 is a functional block diagram generally illustrating an embodiment of an electronic device system for entropic coordinate sampling as disclosed herein.

FIG. 5 is a block diagram generally illustrating an embodiment associated with a method associated with perceptual hashing, in accordance with aspects of the disclosure.

### DETAILED DESCRIPTION OF EMBODIMENTS

Before the present systems and methods are disclosed and described, it is to be understood that the systems and methods are not limited to specific methods, specific components, or to particular implementations. It is also to be understood that the terminology used herein is for the purpose of describing particular embodiments only and is not intended to be limiting. Various embodiments are described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

Disclosed herein are novel systems, methods, and devices for perceptual hashing that uses content-agnostic entropic coordinate sampling. Such use results in faster, memory efficient, and decentralized hashing. The disclosure, furthermore, may be scale-invariant, thus allowing for the automatic capturing of data features at a distribution of spatial scales. Additionally, the disclosure can function in arbitrary dimensions because it makes no assumptions about the structure of the data analyzed. These benefits may serve to improve the speed, efficiency, and use of computer devices as well as the corresponding user experiences.

And where existing approaches only allow for the minting of a single invariant hash from content, the disclosed systems, methods, and devices—when integrated with blockchain technology—provide the additional novel benefits of minting content fragments. This integration may also result in novel and beneficial aspects such as robustness against cropping and collages (ensembles of other works, includes some types of song remixes and spliced video). This is because fragments may solve the collage problem and allow a dynamic/flexible hash length depending on the complexity of the composition. Thus, the general approach of fragmentation may enable a more expressive and useful content-based index of all data on blockchain to create a federated search engine. Fragments can, to a variable extent, approach true semantic segmentation of the content, which can be searched and grouped on a decentralized index. This new type of search engine may function as a user-friendly portal, such as for non-fungible token (NFT) marketplaces. It may also be extendable to other blockchains, such as through the use of bridges.

Content hashes may result from the systems, methods, and devices for perceptual hashing described herein, which may involve entropic coordinate sampling. When integrated with blockchain, such content hashes may allow for a content-based federated search engine that uses the decentralized index for hashed content fragments. This may have the practical effect of, among other things, enabling users to search for content subsets of interest, enforce royalty agreements, and rank content based on arbitrary invariant features. In one embodiment, the disclosed perceptual hashing through entropic coordinate sampling is accomplished by quantizing a content into fragments based on triangles (or any other shape) drawn from peak coordinates in an estimated entropy; transforming the fragments into equilateral triangles; creating rotations; and minting each fragment on the blockchain such that blockchain operations can be run on them.

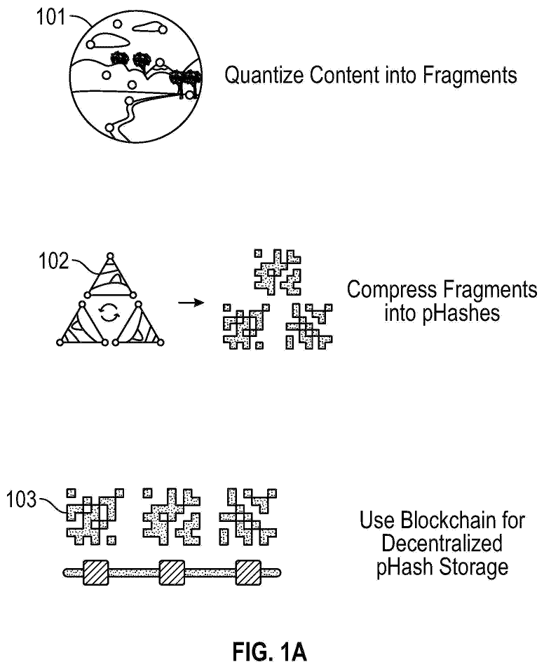

FIG. 1A generally illustrates an embodiment of entropic coordinate sampling as disclosed herein. As shown in FIG. 1A, a method for the entropic coordinate sampling of an image may have three primary steps. The first step 101 may include quantizing a multimedia content into fragments. Embodiments of the first step 101 may vary depending on how coordinates are selected and the way the coordinates are combined to make fragments. In some embodiments, a neural network or convolving simple filters (e.g., a Canny edge filter) may be trivially implemented to select important coordinates. Fragments may be drawn in a variety of ways, such as drawing every possible polygon between the coordinates (resulting in a less memory-efficient process), or in using Delaunay triangular tessellation (which is sensitive to edge coordinates but much more efficient).

The second step 102 may feature a compression process. In one embodiment, the fragments may be compressed or transformed into pHashes. Or the compression process may be exchanged with neural networks (e.g., an encoder-based model: autoencoders, transformers, etc.), dimensionality reduction algorithms, or a DCT approach as disclosed herein. These embodiments have varying strengths and weaknesses that affect user experience (for instance, neural networks are much more expensive and would cost end users more than using DCT).

A third step 103 may include storing a pHash. In some examples, this may involve the use of blockchain for decentralizing pHash storage. In some embodiments, the third step 103 may include using different blockchains and specific data structure for storing the pHashes: centralized (encrypted and accessible to a single party) vs. decentralized (stored with assets in public) implementations. Some embodiments disclosed herein may store fragments IDs in the metadata of the asset so that it is publicly accessible and decentralized. Other content may further require private encryption, such as medical images.

FIG. 1B generally illustrates an embodiment of entropic coordinate sampling as disclosed herein. As shown in FIG. 1B, a method for the entropic coordinate sampling of an image may include first breaking up 105 the contents of the image into fragments. This may be accomplished through the sampling 110 of coordinates with high entropy. The sampling 110 of coordinates from the entropy-filtered data may obtain the maximum amount of unique information, with any prior distribution being used. When sampling 110, content may be representable as a tensor and local entropy may be estimated. In this, coordinates may be sampled from local entropy maxima, thus allowing the method to be content agnostic. Breaking 105 up the contents further comprises using coordinates to draw n-dimensional polygons—i.e., creating fragments 115—within the tensor. In one embodiment, triangles may be deterministically and sparsely sampled to reduce memory. An example sampling strategy is the use of tessellation. Another embodiment could use a deep neural network for region/coordinate proposal and semantic segmentation, using visual salience and classification to choose the best fragments.

Once the contents have been broken up into fragments, transformation invariance is added to the fragments. In one embodiment, polygonal fragments are transformed to be equilateral, and the fragments are rotated in each unique direction in n-dimensional space prior to hashing.

Following the addition of transformation invariance to the fragments, the perceptual hashing 120 of fragments takes place. In one embodiment, a perceptual hash algorithm is applied to each fragment. A standard discrete cosine transform approach may be used, as it is already solved in n-dimensions. In these embodiments, collision frequency is typically a tunable parameter of perceptual algorithms and may depend on the size of the content space. Another embodiment could use deep learning encoder models or other dimensionality reduction techniques to compress fragments into a hash representing a location in a latent space that contains information about relevant features. Different embodiments preserve different features of the data and are invariant to others, which can affect downstream applications. For example, standard DCT pHash is very sensitive to small changes and works well for near-duplicate detection. A deep neural network may be sensitive to a completely different set of features and may see higher level/semantic similarities (like similar poses or dance moves among different people) useful for a search engine or recommendation service (but may not work well for near duplicate detection). Using different fragment perceptual hashes simultaneously can also be done and may be advantageous for indexing different types of information about the content.

After the perceptual hashing of fragments, minting 125 may occur of both the content and fragments' perceptual hashes on blockchain as a decentralized and/or centralized database. This may depend on whether the pHashes/relevant encoding is stored with the file on the NFT or whether also included is a pointer to the pHashes stored off chain. This may allow for the dynamic updating of fragment hashes. In some embodiments, smart contracts may be used to link content 130 with fragments. In some embodiments, minting may relate to storing a reference to a pHash.

With the minting of fragments, users may then perform operations on query hashes in a database or subset of the database on chain via data in the hashes. Notably, while one could previously encode information referring to different components of some content, the processes and methods disclosed herein allow searching the content while all the knowledge about a similarity is stored in a small hash in the metadata of the file. For instance, these operations can include near-duplicate detection of any part of the content for IP protection, search of different features and components, and automatic grouping of similar works or of similar versions of the same work. As a result, the disclosure improves database efficiency and user engagement by enabling users to collaborate on a large scale and automatically group variations.

Embodiments of entropic coordinate sampling as disclosed herein may also allow for an unbiased, decentralized content authenticator, search engine, and content organizer using a blockchain. Novel aspects of this may include but are not limited to content-agnostic (from an a priori distribution) coordinate sampling to estimate scale-independent image entropy; joint indexing of images and hashes of image fragments on a blockchain; mutual information-based uniqueness and originality calculations; the ability to calculate similarity between arbitrarily sized sets of content (such as in organizing images and minor variations of the images); and content-based search engine that doesn't rely solely on keywords and tags.

In some examples, sampling may assist in determining the most informative or important parts, regions, fragments, or points in distinguishing content from other content. In some examples, such sampling may also relate to a compression step (albeit not necessarily the same type of compression as described elsewhere in this disclosure).

Some of these novel aspects may translate into at least the improvements of computer functionality and user experience, such as: improved content retrieval, as a result of the 2D affine transformation invariant; decentralized database combined with hash function; grouping of content based on similarity for large sets of similar works with slight variations; and transparency that enables users to view which fragments matched and to what degree in the case of disputes. Additionally, when compared to wholistic (not fragmented) artificial intelligence-based approaches the disclosure herein provides the advantages of being scalable; faster, data-efficient; and human interpretable, in that it can show which fragments match. The disclosure herein may also provide improved protection and management of digital content, continuous uniqueness scores across arbitrarily sized sets.

Such novel aspects and resulting improvement to computer functionality and user experience may further translate into improved facilitation of creating a historical record of originality of work based on blockchain technology, which can lead to identifying fraudulent works of art or other content, thus improving the ability to electronically determine royalties owed or identifying when content should be removed.

Similarly, invention embodiments of the disclosure may refine spam filtering for low-effort content/copycats, with searching functionalities being improved as a result of the lack of clutter from displaying original content. The disclosure may also improve content organization by finding ‘templates’ (e.g., memes or profile picture projects) using consistently similar content regions.

Additionally, the disclosure may improve user experience by enabling the curation of content for users by way of content similarity. And the disclosure may allow for a cross-platform, content-based search. For example, the disclosure may improve search capability for new types of media synthesis, such as remixes (music), collages (images), and mashups (video), etc. Or, in another example, collectors may also search by sketch or content features such as color placement. Similarly, galleries and collections may curate with unique components. Furthermore, the disclosure may allow for the data collection of content fragment popularity, allowing for recommendation service and content-based appraisal and price estimation.

Notably, though image hashing has been addressed in the above embodiments, the disclosure herein may apply equally to other forms of multimedia, such as video and audio—such that the disclosure herein may be content agnostic because the disclosed systems and methods are applicable to images, audio, and video. For example, multi-chain and web indexing may be performed for a more complete historical record of originality. And input parameters may be tweaked to the hashing algorithm to apply arbitrary improvements.

Thus, in some embodiments, sound entropy may be estimated as a function of time over the signal (such as by convolving an entropy filter). In such embodiments, the convolution may be a 1D operation for audio, such as music. Entropy peaks in the signal may be used to pick high-entropy time coordinates (rather than spatial x, y coordinates for images). Fragments represent sections of the signal between coordinates, with extracting 1D segments of the music. DCT may be used to find the combination of frequencies in the signal segments that represent their characteristic fingerprints. Each segment of the sound data is perceptually hashed according to its component frequencies (just like the 2D image fragments). Hashes may be minted and operated on the blockchain, much like in FIGS. 1A and 1B, regardless of the source content type. And deep neural networks or other formulations may be used to estimate the entropy in the signal and perform the compression for the perceptual hash.

In an embodiment for video content, the disclosed systems and methods may include selecting the highest-entropy frame of frames (using similar entropy estimates as used for the image fragments but using the whole frame as a single image fragment). The systems and methods further include running the highest-entropy image(s) through the image embodiment. In some examples, the query video contains the high-entropy frame or any frames that share even one fragment with the high-entropy frame, then it may be flagged just the same.

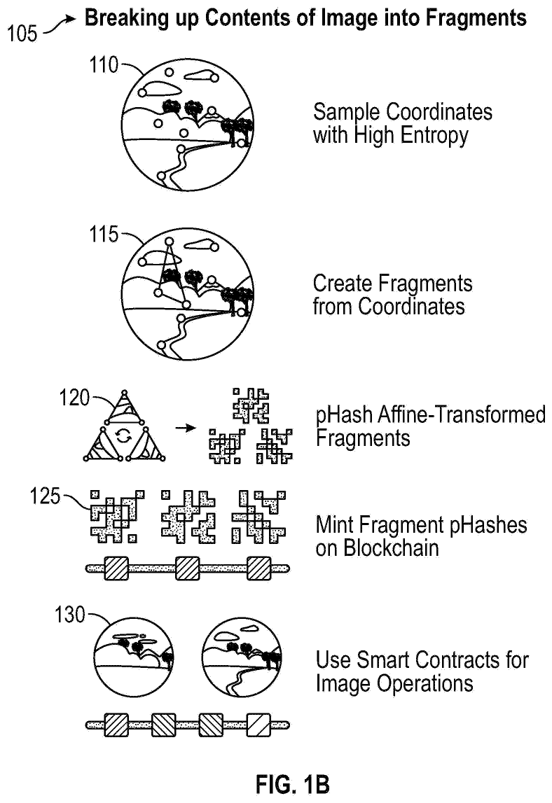

FIG. 2 generally illustrates an embodiment of entropic coordinate sampling 200 as disclosed herein. As shown in FIG. 2, new images may be integrated into a database.

More specifically, as shown by step 205, digital content may be submitted. Digital content may be considered an n-dimensional tensor in some examples.

As shown by step 210, fragments may be generated. In some embodiments, the fragment generation process may be an arbitrary equation that is modified based on what works best or to estimate the entropy at each coordinate or pick key coordinates. Relatedly, an error-robust fragmentation may be performed that segments the content into useful and distinct regions.

As shown at step 215, pHashes may be created, based on transformed fragments. In some examples, such a step may involve a pHash algorithm. In some examples, the pHash algorithm may be flexible and may be implemented in many ways, so long as it's not a cryptographic hash (perceptual and cryptographic are the 2 main types of hashes). One embodiment may employ a DCT-style pHash, but compression or encoding to a latent space can also be used.

At step 220, a search may be performed. In some examples, the search may be of digital content in a database. Prior to a search, pHashes may be encoded to decrease memory footprint on blockchain—for instance, by having a lookup table that assigns the shortest codes to the most common pHashes. Decentralized search of the indexed blockchain may occur in parallel.

As shown at step 225, if digital content is original, it may be passed to step 230. But if digital content is a copy of pre-existing digital content, it may not be passed to step 230.

At step 230, digital content may be appended to an indexed blockchain. In some embodiments, the process for checking an image's status may be the same except without appending at the last step (so the process can just end after pass/fail with no need to append).

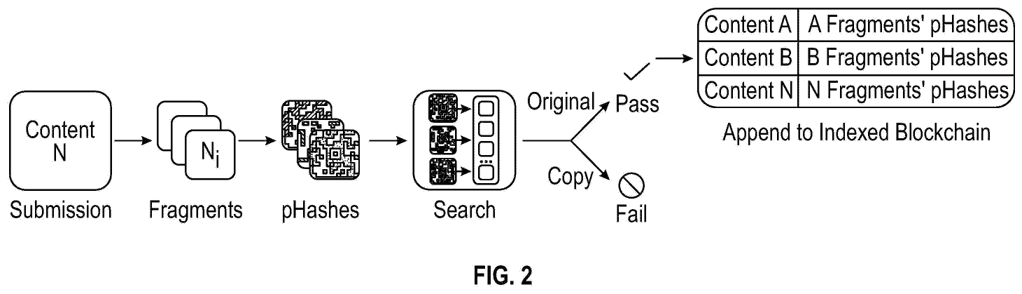

FIG. 3 is a functional block diagram generally illustrating an embodiment of a network system 300 for entropic coordinate sampling as disclosed herein. Shown in FIG. 3 is a entropic coordinate sampling server 305 accessible over a local area networks or a wide area network 310, such as the Internet, by one or more user electronic devices 315, including for example, laptops, smartphones, computers, tablets, and other computing devices that can access the local area network or a wide area network where the form-converter server 305 resides. The server 305 hosts one or more platform 320 for perceptual hashing and connects to a blockchain 330 (the platform 320 and blockchain 330 may also be accessible to users). And the server 305 is remotely accessible by a number of the devices 315. In normal operation, an electronic device 315 connects with the server 305 to interact with the platform 320 or blockchain 330. The platform 330 may employ several connectors to interact with third-party data, services, or applications 325, such as various cloud services, or any other data or service accessible through a network, including local area networks (for example a local application that is exposed as a WebService residing on-premises) or wide area networks (for example the Internet).

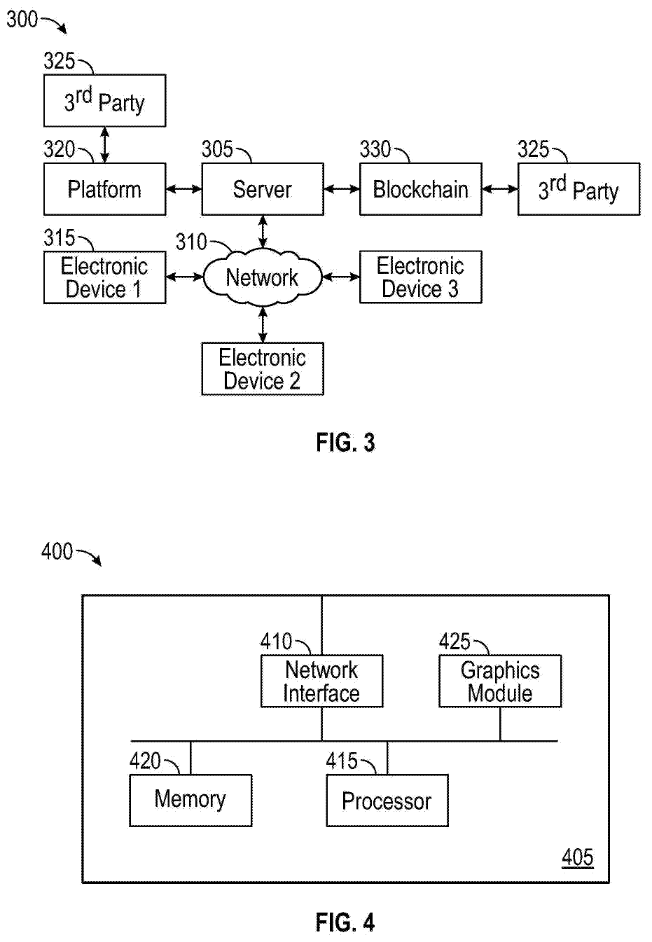

FIG. 4 is a functional block diagram generally illustrating an embodiment of an electronic device system for entropic coordinate sampling as disclosed herein. The electronic device 405 may be coupled to a server via a network interface 410. The electronic device 405 generally comprises a processor 415, a memory 420, and a graphics module 425. The electronic device 405 is not limited to any particular configuration or system.

In some aspects, the function of segmenting may include dividing digital content into different regions.

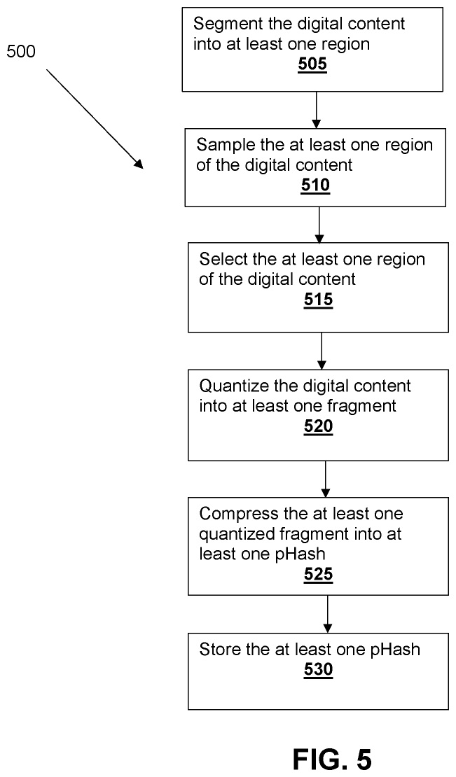

FIG. 5 is a block diagram generally illustrating an embodiment associated with a method of perceptual hashing using entropic sampling 500, in accordance with aspects of the disclosure. Some embodiments may involve at block 505 segmenting the digital content into at least one region. Some embodiments may involve at block 510, sampling the at least one region of the digital content.

Some embodiments may involve at block 515 selecting the at least one region of the digital content. In some examples, such selecting may be based at least in part on the sampling. In some examples, such segmenting and sampling may involve selecting coordinate. In some instances, a neural network or convolving simple filters (such as a Canny edge filter) may be implemented to select important coordinates, although other methods known to persons of ordinary skill in the pertinent arts are also contemplated.

Some embodiments may involve at block 520 quantizing the digital content into at least one fragment. In some examples, such quantizing may be based at least in part on the selecting.

Some embodiments may involve at block 525 compressing the at least one quantized fragment into at least one pHash. In some examples, such compression may involve exchanging with neural networks (any encoder-based model: autoencoders, transformers, etc.), dimensionality reduction algorithms, and/or a selected DCT approach.

Some embodiments may involve at block 530 storing the at least one pHash. Such storing may depend on a specific data structure for storing the pHashes. In some examples, the storing could be to a centralized data structure (which may be encrypted and accessible to a single party). In other examples, the storing could be to a decentralized data structure (stored with assets in public), such as a blockchain.

Other embodiments may include combinations and sub-combinations of features described or shown in the several figures, including for example, embodiments that are equivalent to providing or applying a feature in a different order than in a described embodiment, extracting an individual feature from one embodiment and inserting such feature into another embodiment; removing one or more features from an embodiment; or both removing one or more features from an embodiment and adding one or more features extracted from one or more other embodiments, while providing the advantages of the features incorporated in such combinations and sub-combinations. As used in this paragraph, “feature” or “features” can refer to structures and/or functions of an apparatus, article of manufacture or system, and/or the steps, acts, or modalities of a method.

References throughout this specification to “one embodiment,” “an embodiment,” “an example embodiment,” etc., indicate that the embodiment described may include a particular feature, structure, or characteristic, but every embodiment may not necessarily include that particular feature, structure, or characteristic. Moreover, such phrases are not necessarily referring to the same embodiment. Further, when a particular feature, structure, or characteristic is described in connection with one embodiment, it will be within the knowledge of one skilled in the art to affect such feature, structure, or characteristic in connection with other embodiments whether or not explicitly described.

Unless the context clearly indicates otherwise (1) the word “and” indicates the conjunctive; (2) the word “or” indicates the disjunctive; (3) when the article is phrased in the disjunctive, followed by the words “or both,” both the conjunctive and disjunctive are intended; and (4) the word “and” or “or” between the last two items in a series applies to the entire series.

Where a group is expressed using the term “one or more” followed by a plural noun, any further use of that noun to refer to one or more members of the group shall indicate both the singular and the plural form of the noun. For example, a group expressed as having “one or more members” followed by a reference to “the members” of the group shall mean “the member” if there is only one member of the group.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

Embodiments of the systems and methods are described with reference to schematic diagrams, block diagrams, and flowchart illustrations of methods, systems, apparatuses, and computer program products. It will be understood that each block of the block diagrams, schematic diagrams, and flowchart illustrations, and combinations of blocks in the block diagrams, schematic diagrams, and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

Other embodiments may comprise overlay features demonstrating relationships between one more steps, active users, previous users, missing steps, errors in the workflow, analytical data from use of the workflow, future use of the workflow, and other data related to the workflow, users, or the relationship between the workflow and users.

These and other features and characteristics of the present technology, as well as the methods of operation and functions of the related elements of structure and the combination of parts and economies of manufacture, will become more apparent upon consideration of the description herein and the appended claims with reference to the accompanying drawings, all of which form a part of this specification, wherein reference numerals designate corresponding parts in the various figures. It is to be expressly understood, however, that the drawings are for the purpose of illustration and description only and are not intended as a definition of the limits of the disclosure.

In addition, the various illustrative logical blocks, modules, and circuits described in connection with certain embodiments disclosed herein may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but is not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred in any respect. This holds for any possible non-express basis for interpretation, including matters of logic with respect to arrangement of steps or operational flow, plain meaning derived from grammatical organization or punctuation, or the number or type of embodiments described in the specification.

What is claimed is:

1. A method for integrating digital content, the method comprising:
segmenting the digital content into at least one region;
sampling the at least one region of the digital content;
selecting, based at least in part on the sampling, the at least one region of the digital content;
quantizing, based at least in part on the selecting, the digital content into at least one fragment;
compressing the at least one quantized fragment into at least one pHash; and
storing the at least one pHash.

2. The method of claim 1, wherein the at least one region is distinct from the at least one fragment.

3. The method of claim 2, further comprising:
utilizing smart contracts for image operations.

4. The method of claim 2, wherein the sampling comprises:
estimating entropy associated with the at least one region; and
determining that the estimated entropy associated with the at least one region is high,
wherein the selecting is based at least in part on the determining.

5. The method of claim 4, wherein the determining comprises:
identifying peak entropy coordinates within the at least one region.

6. The method of claim 5, further comprising:
creating geometric boundaries based at least in part on the identified peak coordinates.

7. The method of claim 6, where the created geometric boundaries are associated with created triangles.

8. The method of claim 7, wherein the quantizing is based at least in part on the creating.

9. The method of claim 5, further comprising drawing the at least one fragment, based on least in part on the identified peak entropy coordinates.

10. The method of claim 2, wherein the storing further comprises:
utilizing a blockchain.

11. The method of claim 10, wherein the storing further comprises storing the at least one pHash in a database.

12. The method of claim 2, wherein the digital content comprises at least one of an image file and a sound file.

13. A computing device comprising:
a processor;
a memory; and
a non-transitory, computer-readable medium operably coupled to the processor, the computer-readable medium having computer-readable instructions stored thereon that, when executed by the processor, cause the computing device to:
segment the digital content into at least one region;
sample the at least one region of the digital content;
select, based at least in part on the sampling, the at least one region of the digital content;
quantize, based at least in part on the selecting, the digital content into at least one fragment;
compress the at least one quantized fragment into at least one pHash; and
store the at least one pHash.

14. The computing device of claim 13, wherein the at least one region is distinct from the at least one fragment.

15. The computing device of claim 14, wherein the computer-readable instructions that cause the computing device to store utilize a blockchain.

16. The computing device of claim 14, wherein the computer-readable instructions that further cause the computing device to store further comprise storing the at least one pHash in a database.

17. The computing device of claim 14, wherein the computer-readable instructions further cause the computing device to:
utilize smart contracts for image operations.

18. The computing device of claim 14, wherein the computer-readable instructions further cause the computing device to:
estimate entropy associated with the at least one region; and
determine that the estimated entropy associated with the at least one region is high,
wherein the selecting is based at least in part on the determining.

19. The computing device of claim 18, wherein the computer-readable instructions further cause the computing device to:
identify peak entropy coordinates within the at least one region.

20. The computing device of claim 19, wherein the computer-readable instructions further cause the computing device to:
draw the at least one fragment, based on least in part on the identified peak entropy coordinates.
